(19) United States
(12) Patent Application Publication
(10) Pub. No.: US 2015/0051865 A1
(43) Pub. Date: Feb. 19, 2015

(54) BIAS CALCULATION METHOD AND BIAS CALCULATION DEVICE

(71) Applicants: Yimei Ding, Shiojiri-shi (JP); Daisuke Sugiya, Chino-shi (JP)

(72) Inventors: Yimei Ding, Shiojiri-shi (JP); Daisuke Sugiya, Chino-shi (JP)

(21) Appl. No.: 14/456,987

(22) Filed: Aug. 11, 2014

(30) Foreign Application Priority Data
Aug. 14, 2013 (JP) 2013-168534

(51) Int. Cl. G01P 15/00; G01P 21/00

(52) U.S. Cl. CPC G01P 15/00; G01P 21/00
USPC 702/141

(57) ABSTRACT

A position calculation device which includes a sensor unit having an acceleration sensor and a gyro sensor is rotated around a vertical direction as an axial center in a state where a plane defined by a first axis and a second axis of the acceleration sensor is substantially perpendicular to the vertical direction. The bias of each of the first axis and the second axis of the acceleration sensor is calculated using a detection value of the sensor unit obtained during rotation.

### CROSS-REFERENCE

This application claims priority to Japanese Patent Application No. 2013-168534, filed Aug. 14, 2013, the entirety of which is hereby incorporated by reference.

### BACKGROUND

1. Technical Field

The present invention relates to a bias calculation method and a bias calculation device which calculate the bias of an acceleration sensor.

2. Related Art

In various fields of so-called seamless positioning, motion sensing, attitude control, and the like, the utilization of an inertial sensor is now attracting attention. As the inertial sensor, an acceleration sensor, a gyro sensor, a pressure sensor, a geomagnetic sensor, and the like are widely known.

For example, the output of an acceleration sensor as a kind of inertial sensor includes a bias (acceleration bias) which is represented by a zero-point bias. Although the output of the acceleration sensor is used in, for example, an inertial navigation operation or the like, there is a possibility that a large error occurs in the operation result due to the acceleration bias. For this reason, the acceleration bias is calculated (estimated) in advance, and when using the output value of the acceleration sensor, it is necessary to take the acceleration bias into consideration. As a technique for calculating the acceleration bias, JP-A-2012-8096 discloses a technique which arranges the detection axis of the acceleration sensor in conformity with a vertical direction (a direction in which gravity is applied), thereby calculating the acceleration bias of the detection axis.

However, according to the above-described technique, the acceleration bias for one axis is calculated. That is, in a case of a multi-axis acceleration sensor, it is necessary to arrange a plurality of detection axes (three axes) in conformity with the vertical direction in order and to perform the calculation of the acceleration bias of each detection axis, thereby requiring a lot of time and labor.

On the other hand, since the acceleration sensor is likely to be influenced by change in external temperature, temperature compensation is performed. However, even if the temperature compensation is performed, a turn-on bias which is a bias generated each time power is turned on or a bias which is included in the output of the acceleration sensor by the influence of external conditions other than temperature does not become zero. For this reason, each time power is turned on and use starts, it is necessary to perform the calculation (initial calibration) of the acceleration bias; however, as described above, the calculation of the acceleration bias for each axis toward the vertical direction each time is very cumbersome.

### SUMMARY

An advantage of some aspects of the invention is that it easily performs calculation of a bias value of an acceleration sensor while reducing time and labor.

A first application example is directed to a bias calculation method including: calculating a bias of each of a first axis and a second axis of an acceleration sensor using a detection value of a sensor unit including the acceleration sensor and a gyro sensor acquired when the sensor unit is rotated around a vertical direction as an axial center in a state where a plane defined by the first axis and the second axis of the acceleration sensor is substantially perpendicular to the vertical direction.

As another application example, the invention may be configured as a bias calculation device including: a sensor unit having an acceleration sensor and a gyro sensor; a notification control unit which gives notification to the effect of rotating the sensor unit around a vertical direction as an axial center in a state where a plane defined by the first axis and the second axis of the acceleration sensor is substantially perpendicular to the vertical direction; and a bias calculation unit which calculates the bias of the first axis and the second axis of the acceleration sensor using a detection value of the sensor unit.

According to the first application example and the like, the sensor unit having the acceleration sensor and the gyro sensor is rotated around the vertical direction as the axial center in a state where the plane defined by the first axis and the second axis of the acceleration sensor is substantially horizontally placed, whereby it is possible to calculate the bias of both the first axis and the second axis of the acceleration sensor.

A second application example is directed to the bias calculation method of the application example described above, wherein the calculating of the bias includes calculating a plurality of instantaneous establishment conditions, in which the attitude of the sensor unit is represented using the detection value with the bias as an unknown, during the rotation, and deciding the bias using the plurality of instantaneous establishment conditions.

According to the second application example, a plurality of instantaneous establishment conditions, in which the attitude of the sensor unit is represented using the detection value with the bias as an unknown, during the rotation, and the bias of the acceleration sensor is calculated using the calculated instantaneous establishment conditions. During the rotation, the attitude of the sensor unit changes at every moment. That is, the instantaneous establishment conditions are generated in a plurality of states where the attitude of the sensor unit is different. The larger the number of instantaneous establishment conditions, the higher the calculation precision of the bias can be.

A third application example is directed to the bias calculation method of the application example described above, which further includes determining the attitude angle of the sensor unit using the detection value of the sensor unit, wherein, in the calculating of the instantaneous establishment conditions, the instantaneous establishment conditions are calculated using the detection value, the attitude angle, and a gravitational acceleration.

According to the third application example, the instantaneous establishment conditions are calculated using the detection value of the sensor unit, the attitude angle of the sensor unit determined using the detection value of the sensor unit, and the gravitational acceleration.

A fourth application example is directed to the bias calculation method of the application example described above, wherein, in the determining of the attitude angle, an initial attitude angle is determined using a detection value of the acceleration sensor in a state where the sensor unit is stopped and the gravitational acceleration, and a previously determined attitude angle is updated using a detection value of the gyro sensor to determine an attitude angle in each of a plurality of attitudes.

According to the fourth application example, as the determination of the attitude angle, the initial attitude angle is determined using the detection value of the acceleration sensor in a state where the sensor unit is stopped and the gravitational acceleration, and the previously determined attitude angle is updated using the detection value of the gyro sensor to perform the determination of the attitude angle in each of a plurality of attitudes.

A fifth application example is directed to the bias calculation method of the application example described above, wherein, in the deciding of the bias, predetermined approximation computation using a plurality of instantaneous establishment conditions is performed to decide the bias.

According to the fifth application example, the predetermined approximation computation using a plurality of instantaneous establishment conditions is performed, whereby the bias is calculated.

A sixth application example is directed to the bias calculation method of the application example described above, wherein, in the rotating, the sensor unit is rotated in a state where the sum of the angle between the first axis and a horizontal plane perpendicular to the vertical direction and the angle between the second axis and the horizontal plane is equal to or less than 10 degrees.

According to the sixth application example, the sensor unit is rotated in a state where the sum of the angle between the first axis and the horizontal plane perpendicular to the vertical direction and the angle between the second axis and the horizontal plane is equal to or less than 10 degrees, whereby it is possible to calculate the acceleration bias.

A seventh application example is directed to the bias calculation method of the application example described above, wherein the sensor unit is mounted on a trunk, a head, or a leg of a user for use.

According to the seventh application example, the sensor unit is mounted on the trunk, the head, or the leg of the user in a state where the plane defined by the first axis and the second axis of the acceleration sensor is substantially horizontally placed, and the bias of the acceleration sensor can be calculated by simple operation of the user to rotate in the left-right direction on the spot.

### BRIEF DESCRIPTION OF THE DRAWINGS

The invention will be described with reference to the accompanying drawings, wherein like numbers reference like elements.

FIG. 1 is an overall configuration diagram of a position calculation device.

FIG. 2 shows a calculation experiment result of an acceleration bias.

FIG. 3 is a functional configuration diagram of the position calculation device.

FIG. 4 shows a data configuration example of data for acceleration bias calculation.

FIG. 5 shows a data configuration example of acceleration bias data.

FIG. 6 is a flowchart of acceleration bias calculation processing.

### DESCRIPTION OF EXEMPLARY EMBODIMENTS

### Overall Configuration

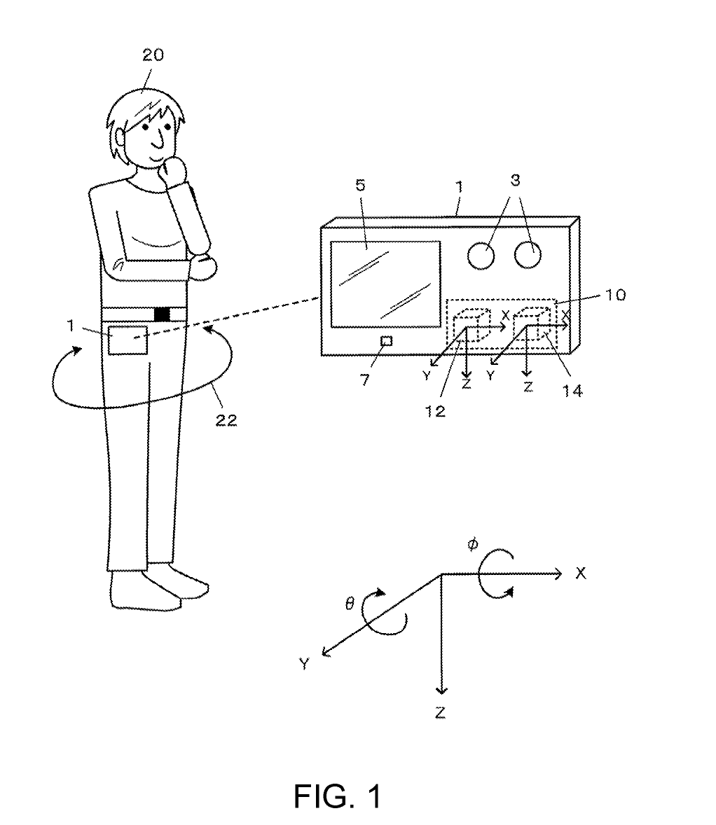

FIG. 1 is an overall configuration diagram of a position calculation device 1 of an embodiment. The position calculation device 1 is a small electronic apparatus which is mounted on a waist of a user 20 for use, and can perform an inertial navigation operation to calculate the position of the device. The position calculation device 1 is provided with an operation switch 3, a display 5, a speaker 7, and the like, and is embedded with an IMU (Inertial Measurement Unit) 10 and a control device having a CPU (Central Processing Unit) and a memory mounted therein.

The IMU 10 is a sensor unit which has an acceleration sensor 12 and a gyro sensor 14. The acceleration sensor 12 detects acceleration in a local coordinate system (sensor coordinate system) which is a three-dimensional orthogonal coordinate system associated with the sensor. The gyro sensor 14 detects angular velocity in a local coordinate system (sensor coordinate system) which is a three-dimensional orthogonal coordinate system associated with the sensor. Although a case where the sensor coordinate system of the acceleration sensor 12 and the sensor coordinate system of the gyro sensor 14 have the same coordinate axes is described, when the coordinate axes are different, if a coordinate transformation matrix operation is performed, it is possible to substitute one coordinate system with the other coordinate system. The coordinate transformation matrix operation can be performed by means of a known method, thus, description thereof will be omitted.

The position calculation device 1 is configured to be mounted on the user 20 in an attitude, in which the Z axis of the local coordinate system turns vertically downward, and an X-Y plane is substantially horizontally placed (substantially perpendicular to a vertical direction), as a recommending attitude. In this embodiment, the X axis and the Y axis correspond to a first axis and a second axis. The position calculation device 1 is also a bias calculation device which calculates the bias of each of the detection axes of the acceleration sensor 12.

### Principle

In this embodiment, it is assumed that the output of the acceleration sensor 12 is subjected to temperature compensation. That is, the output of the acceleration sensor 12 includes a component (temperature-dependent component) depending on temperature, such as a zero-point bias, a scale factor, or quadratic sensitivity. The temperature characteristic of the temperature-dependent component is obtained and compensated in a manufacturing step of the acceleration sensor 12. The temperature compensation may be performed inside the acceleration sensor 12 or may be performed outside the acceleration sensor 12. That is, a circuit unit for temperature compensation may be provided inside the acceleration sensor 12 and the output value of the acceleration sensor 12 may be already subjected to temperature compensation, or a processing circuit unit may be provided separately from the acceleration sensor 12 to perform temperature compensation (more accurately, correction) for the output value of the acceleration sensor 12. In any case, in this embodiment, a value which is detected by the acceleration sensor 12 and subjected to temperature compensation is described as a detection value of the acceleration sensor 12.

However, even if the temperature compensation is performed, the bias included in the detection value does not become completely zero due to a turn-on bias generated every time of power-on, or a bias component other than a temperature-dependent component, and the bias value remains. This embodiment is to estimate the magnitude of the bias remaining the detection value.

### (A) During Stop

First, the estimation of the bias of the acceleration sensor 12 during stop will be described. During stop, only gravity is applied to the acceleration sensor 12. It is assumed that the bias values to be estimated of the respective detection axes (X, Y, and Z axes) of the acceleration sensor 12 are bₐ=(bₐₓ, b_{ay}, b_{az}).

As an ideal state, when the acceleration sensor 12 is provided such that the Z axis turns vertically downward (that is, an X-Y plane is completely horizontally placed), the detection values f=(fₓ, f_{y}, f_{z}) of the respective detection axes (X, Y, and Z axes) of the acceleration sensor 12 are given by Expression (1). That is, the bias values bₐ=(bₐₓ, b_{ay}, b_{az}) of the respective detection axes (X, Y, and Z axes) of the acceleration sensor 12 are easily obtained.

fₓ=bₐₓ

f_{y}=b_{ay}

f_{z}=−g+b_{az} (1)

However, actually, it is difficult to provide the acceleration sensor 12 such that the X-Y plane is completely horizontally placed. If the inclination of the X-Y plane with respect to a horizontal plane (a plane perpendicular to the vertical direction) is the attitude of the acceleration sensor 12 and expressed by a roll angle φ which is the rotation angle around the X axis and a pitch angle θ which is the rotation angle around the Y axis, the detection values f=(fₓ, f_{y}, f_{z}) of the respective detection axes (X, Y, and Z axes) of the acceleration sensor 12 are given by Expression (2).

$$( \begin{matrix}{f}_{x} \\ {f}_{y} \\ {f}_{z}\end{matrix} ) = ( \begin{matrix}cos θ \cdot cos ψ & cos θ \cdot sin ψ & - sin θ \\ \begin{matrix}- cos φ \cdot sin ψ + sin φ \cdot \\ sin θ \cdot cos ψ \cdot cos φ\end{matrix} & cos ψ + sin φ \cdot sin θ \cdot sin ψ & sin φ \cdot cos θ \\ \begin{matrix}sin φ \cdot sin ψ + \\ cos φ \cdot sin θ \cdot cos ψ\end{matrix} & \begin{matrix}- sin φ \cdot cos ψ + \\ cos φ \cdot sin θ \cdot sin ψ\end{matrix} & cos φ \cdot cos θ\end{matrix} ) ( \begin{matrix}0 \\ 0 \\ - g\end{matrix} ) + ( \begin{matrix}{b}_{ax} \\ {b}_{ay} \\ {b}_{az}\end{matrix} ) \qquad ( 2 )$$

Although Expression (2) is expressed by matrix, Expression (2) is altered to Expression (3) without using matrix.

fₓ=g·sin θ+bₐₓ

f_{y}=−g·sin φ·cos θ+b_{ay}

f_{z}=−g·cos φ·cos θ+b_{az} (3)

As will be understood from Expression (3), the detection values f=(fₓ, f_{y}, f_{z}) of the acceleration sensor 12 include two components of each axial direction component of a gravitational acceleration g and a bias component. Since the attitude angles φ and θ of the acceleration sensor 12 are unknown, it is difficult to calculate the bias values bₐ=(bₐₓ, b_{ay}, b_{az}) from Expression (3). Accordingly, in this embodiment, in Expression (3), the bias values included in the detection values of the acceleration sensor 12 are estimated using temporary attitude angles which are attitude angles when it is assumed that the bias is zero.

In Expression (3), the temporary attitude angles φ^{t} and θ^{t} which are attitude angle when it is assumed that the bias of the acceleration sensor 12 is zero (bₐₓ=0, b_{ay}=0, b_{az}=0) are expressed by Expression (4).

$${φ}^{t} = arctan 2 ( - {f}_{y} - {f}_{z} ) \\ {θ}^{t} = arctan ( \frac{{f}_{x}}{\sqrt{{f}_{y}^{2} + {f}_{z}^{2}}} ) \qquad ( 4 )$$

Since the acceleration sensor 12 is arranged such that the X-Y plane is substantially horizontally placed, the attitude angles φ and θ are sufficiently small (φ+θ≦10 degrees). For this reason, the temporary attitude angles φ^{t} and θ^{t} are also approximately obtained by Expression (5).

$${φ}^{t} = arcsin ( - \frac{{f}_{y}}{g} ) \approx - \frac{{f}_{y}}{g} \\ {θ}^{t} = arcsin ( \frac{{f}_{x}}{g} ) \approx - \frac{{f}_{x}}{g} \qquad ( 5 )$$

Attitude angle errors δφ and δθ which are the difference between the temporary attitude angles φ^{t} and θ^{t} and actual attitude angles φ and θ are expressed by Expression (6).

$$δφ = {φ}^{t} - φ = - ( \frac{{b}_{ay}}{g} ) \\ δθ = {θ}^{t} - θ = ( \frac{{b}_{ax}}{g} ) \qquad ( 6 )$$

In Expression (3), the bias values which are calculated (calculated backward) from the temporary attitude angles φ^{t} and θ^{t} are referred to as temporary bias values b^{t}=(bₐₓ^{t}, b_{ay}^{t}, b_{az}^{t}). The difference between the temporary bias value b^{t} and an actual bias value b is referred to as a bias error δb.

δbₐₓ=bₐₓ^{t}−bₐₓ

δb_{ay}=b_{ay}^{t}−b_{ay}

δb_{az}=b_{az}^{t}−b_{az} (7)

As one of the points of this embodiment, it is found that, if variation in the zero-point bias of the acceleration sensor 12 is equal to or less than an error variance σ mg, errors of the attitude angles φ and θ obtained from the detection values of the acceleration sensor 12 during stop in disregard of the zero-point bias are substantially equal to or less than arcsin(0.001σ).

The error variance σ of the bias value represents spread of error of the bias value of the acceleration sensor 12. In this embodiment, since the output of the acceleration sensor 12 is not subjected to temperature compensation, the bias value included in the detection value becomes a value in which an error due to a temperature-dependent component is reduced. However, the bias values in all of the acceleration sensors 12 are not uniform due to variation between products.

Variation between products can be measured through, for example, a test using a test device in a manufacturing step of the acceleration sensor 12. That is, after temperature compensation is performed for each of the products of the acceleration sensors 12, the bias value which remains in the detection value of the acceleration sensor 12 is measured, thereby obtaining an error distribution of the bias value. The spread of error of the bias value is obtained as the error variance σ from the error distribution of the bias value. The error variance σ can be obtained as, for example, a standard deviation or a variance value of the bias value.

In recent years, as a small and inexpensive inertial sensor, a MEMS sensor to which a semiconductor micro-machining technique is applied is mounted in various consumer appliances. If the MEMS sensor is taken as an example, the bias value of the acceleration sensor 12 subjected to temperature compensation becomes a value in the order of mg=0.001 g. In this embodiment, the error variance σ of the bias value is represented as “σ mg” for the acceleration sensor 12 by the MEMS sensor.

First, the pitch angle θ will be described. Expression (8) is obtained from the expression of the detection value fₓ of the X axis in Expression (3).

|fₓ−g·sin θ|=|bₐₓ| (8)

Since variation in the zero-point bias of the acceleration sensor 12 is equal to or less than the error variance σ mg (bₐₓ≦σ mg), Expression (8) becomes Expression (9).

$$\vert \frac{{f}_{x}}{g} - sin θ \vert \leq 0.001 σ \qquad ( 9 )$$

From Expressions (5) and (6), Expression (9) becomes Expression (10).

|sin θ^{t}−sin θ|≦0.001σ

|sin(θ+δθ)−sin θ|≦0.001σ (10)

Since the pitch angle θ and the pitch angle error δθ are sufficiently small (φ+θ≦10 degrees), if it is approximated to be cos θ≅1 and cos δθ≅1, Expression (10) becomes Expression (11).

$$\vert cos θ \cdot sin δθ \vert \leq 0.001 σ \\ \vert sin δθ \vert \leq \frac{0.001 σ}{cos θ} \\ \vert sin δθ \vert \leq 0.001 σ \\ \vert δθ \vert \leq {sin}^{- 1} ( 0.001 σ ) \qquad ( 11 )$$

According to Expression (11) which represents the pitch angle error δθ, if error of the zero-point bias of the acceleration sensor 12 is equal to or less than 10 mg, the pitch angle error δθ and the roll angle error δφ in disregard of the zero-point bias are substantially equal to or less than 0.6 deg.

Subsequently, in Expression (3), the bias value b_{az} of the Z axis of the acceleration sensor 12 is expressed by Expression (12).

b_{az}=f_{z}+g·cos φ·cos θ (12)

From Expression (12), Expression (13) which represents the temporary bias value b_{az} of the Z axis using the temporary attitude angles φ^{t} and θ^{t} are established.

b_{az}^{t}=f_{z}+g·cos φ^{t}·cos θ^{t} (13)

Expression (13) becomes Expression (14) from Expression (6).

$$\begin{matrix}{b}_{az}^{t} = {f}_{z} + g \cdot cos ( φ + δφ ) cos ( θ + δθ ) \\ = {f}_{z} + g ( cos φ \cdot cos θ - sin φ \cdot cos θ \cdot sin δφ - \\ cos φ \cdot sin θ \cdot sin δθ )\end{matrix} \qquad ( 14 )$$

Since attitude angle errors δφ and δθ are sufficiently small (φ+θ≦10 degrees), if it is approximated to be cos θ≅1, cos δθ≅1, δθ≅δφ, and sin δφ·sin δθ≅0, Expression (14) becomes Expression (15).

b_{az}^{t}≈f_{z}+g·cos φ·cos θ−g·sin δθ·sin(φ+θ) (15)

From Expression (7), error δb_{az} of the bias value b_{az} of the Z axis of the acceleration sensor 12 is expressed by Expression (16).

|δb_{az}|≈g|sin δθ·sin(φ+θ)| (6)

From Expression (11), Expression (16) becomes Expression (17).

|δb_{az}|≦g·0.001σ·sin(φ+θ)≦σ_{mg}·|sin(φ+θ)| (17)

Similarly, error δbₐₓ of the bias value bₐₓ of the X axis of the acceleration sensor 12 is obtained and expressed by Expression (18).

|δbₐₓ|≈g|sin δθ·cos θ|≦σ_{mg}·|cos θ| (18)

Similarly, error δb_{ay} of the bias value b_{ay} of the Y axis of the acceleration sensor 12 is obtained and expressed by Expression (19).

|δb_{ay}|≈g|sin δθ·cos(φ+θ)|≦σ_{mg}·|cos(φ+θ)| (19)

In this way, from Expressions (17) to (19), it can be said that the bias errors δbₐₓ, δb_{ay}, and δb_{az} of the respective detection axes (X, Y, and Z axes) of the acceleration sensor 12 during stop depend on the attitude angles φ and θ and the attitude angle errors δφ and δθ.

Since the acceleration sensor 12 is arranged such that the X-Y plane is horizontally placed, the attitude angles φ and θ are small. As the attitude angles φ and θ are small, since sin(θ+φ)→0 and cos θ and cos(θ+φ)→1 are taken, it can be said that the bias error δb_{az} of the Z axis is less than the errors δbₐₓ and δb_{az} of the X and Y axes. For example, when the sum of the attitude angles φ and θ is equal to or less than 10 degrees (φ+θ≦10 degrees), and the zero-point bias of the acceleration sensor 12 is σ mg, the bias errors δbₐₓ, δb_{ay}, and δb_{az} to be estimated of the respective detection axes (X, Y, and Z axes) are expressed by Expression (20).

|δbₐₓ|≦0.17 σmg (20)

According to Expression (20), since the bias error δb_{az} of the Z axis is small during stop, the bias value b_{az} of the Z axis can be calculated from Expression (3). In regard to the X and Y axes, according to Expressions (18) and (19), since the bias errors δbₐₓ and δb_{ay} are large (close to the error variance σ), it is difficult to accurately calculate the bias values bₐₓ and b_{ay}.

### (B) Rotation

Accordingly, in this embodiment, the acceleration sensor 12 is axially rotated around the Z axis as a rotation axis (rotated around the vertical direction as an axial center), thereby calculating the bias values bₐₓ and b_{ay} of the X and Y axes. As described above, only gravity is applied vertically downward during stop. When the acceleration sensor 12 is rotated, and the Z axis and the rotation axis substantially conform to each other, since a rotation force other than gravity is negligible, it can be regarded that only gravity in a vertically downward direction is applied as during stop. Specifically, as shown in FIG. 1, the user 20 performs an operation to rotate the waist in the left-right direction (horizontal direction) as indicated by arrow 22 in a state where the position calculation device 1 is mounted with the Z axis substantially in conformity with the vertically downward direction.

First, the time at which the acceleration sensor 12 is stopped is referred to as the time t_{O}, and from the initial attitude angles φ_{O} and φ_{O} at this time, the detection value f_{xO} of the X axis is expressed by Expression (21).

fₓ₀=g·sin θ₀+bₐₓ (21)

During the rotation of the acceleration sensor 12, the attitude angles φ and θ are changed. From the attitude angles φᵢ and θᵢ at the time tᵢ (where i=1, 2, . . . ) during the rotation, the detection value fₓ of the X axis at the time tᵢ is expressed by Expression (22). However, the time tᵢ is defined as tᵢ=tᵢ₋₁+dt.

$${f}_{x 1} = g \cdot sin {θ}_{1} + {b}_{ax} \\ {f}_{x 2} = g \cdot sin {θ}_{2} + {b}_{ax} \\ ⋮ \\ {f}_{xi} = g \cdot sin {θ}_{i} + {b}_{ax} \qquad ( 22 )$$

The attitude angles φ and θ are obtained by a detection value (angular velocity ω) of the gyro sensor 14. That is, if the detection values (angular velocity) of the respective detection axes (X, Y, and Z axes) of the gyro sensor 14 at the time tᵢ are ωᵢ=(ωₓᵢ, ω_{yi}, ω_{zi}), the temporary attitude angles φ₁^{t} and φ₁^{t} at the time t₁ are given as update values for the temporary attitude angles φ_{O}^{t} and θ_{O}^{t} at the preceding time t_{O} and are expressed by Expression (23).

$$\begin{matrix}{φ}_{1}^{t} = {φ}_{0}^{t} + {θ}_{0}^{t} \cdot {ω}_{z 1} \cdot dt + {ω}_{x 1} \cdot dt \\ = {φ}_{1} + δφ + δθ \cdot {ω}_{z 1} \cdot dt\end{matrix} \\ \begin{matrix}{θ}_{1}^{t} = {θ}_{0}^{t} - {φ}_{0}^{t} \cdot {ω}_{z 1} \cdot dt + {ω}_{y 1} \cdot dt \\ = {θ}_{1} + δθ - δφ \cdot {ω}_{z 1} \cdot dt\end{matrix} \qquad ( 23 )$$

Accordingly, from Expression (22), Expression (24) which represents the bias value bₐₓ at the time t₁ is established.

$$\begin{matrix}{f}_{x 1} - g \cdot sin {θ}_{1}^{t} = {f}_{x 1} - g \cdot ( {θ}^{t} - {φ}^{t} \cdot {ω}_{z 1} \cdot dt + {ω}_{y 1} \cdot dt ) \\ = {f}_{x 1} - g \cdot ( {θ}_{1} + δθ - δφ \cdot {ω}_{z 1} \cdot dt ) \\ = {b}_{ax} - {b}_{ax} + g \cdot δφ \cdot {ω}_{z 1} \cdot dt \\ = - {b}_{ay} \cdot {ω}_{z 1} \cdot dt\end{matrix} \qquad ( 24 )$$

Similarly, the temporary attitude angles φ₂^{t} and θ₂^{t} at the next time t₂ are given as update values for the temporary attitude angles φ₁^{t} and θ₁^{t} at the preceding time t₁ and are expressed by Expression (25).

$$\begin{matrix}{φ}_{2}^{t} = {φ}_{1}^{t} + {θ}_{1}^{t} \cdot {ω}_{z 2} \cdot dt + {ω}_{x 2} \cdot dt \\ = {φ}_{2} + δφ + δθ ( {ω}_{z 1} + {ω}_{z 2} ) \cdot dt - δφ \cdot {ω}_{z 1} \cdot {ω}_{z 2} \cdot {dt}^{2}\end{matrix} \\ \begin{matrix}{θ}_{2}^{t} = {θ}_{1}^{t} - {φ}_{1}^{t} \cdot {ω}_{z 2} \cdot dt + {ω}_{y 2} \cdot dt \\ = {θ}_{2} + δθ - δφ ( {ω}_{z 1} + {ω}_{z 2} ) \cdot dt - {ω}_{z 1} \cdot {ω}_{z 2} \cdot {dt}^{2}\end{matrix} \qquad ( 25 )$$

Accordingly, from Expression (22), Expression (26) which represents the bias value bₐₓ at the time t₂ is established.

$$\begin{matrix}{f}_{x 2} - g \cdot sin {θ}_{2}^{t} = {f}_{x 2} - g \cdot ( {θ}_{2} + δθ - δφ \cdot ( {ω}_{z 1} + {ω}_{z 2} ) \cdot dt - \\ δθ \cdot {ω}_{z 1} \cdot {ω}_{z 2} \cdot {dt}^{2} ) \\ = g \cdot {δφ}_{1} \cdot ( {ω}_{z 1} + {ω}_{z 2} ) \cdot dt + g \cdot δθ \cdot {ω}_{z 1} \cdot {ω}_{z 2} \cdot {dt}^{2} \\ = - {b}_{ay} \cdot ( {ω}_{z 1} + {ω}_{z 2} ) \cdot dt + {b}_{ax} \cdot {ω}_{z 1} \cdot {ω}_{z 2} \cdot {dt}^{2}\end{matrix} \qquad ( 26 )$$

Similarly, at the next time t₃, the temporary attitude angles φ₃^{t} and θ₃^{t} are given as update values for the temporary attitude angles φ₂^{t} and θ₂^{t} at the preceding time t₂, and an expression “fₓ₃−g·sin θ₃^{t}” for the bias value bₐₓ at the time t₃ can be obtained from Expression (22) using the temporary attitude angles φ₃^{t} and θ₃^{t}. The same applies to the subsequent time t₃, t₄, . . . .

In this way, according to Expressions (24) and (26), as shown in Expression (27), it can be said that the expression “fₓ−g·sin θ^{t}” which represents the bias value bₐₓ of the X axis is a linear combination of the bias values bₐₓ and b_{ay} of unknowns. Expression (27) is called “X-axis establishment conditional expression”.

fₓ−g·sin θ^{t}A·bₐₓ+B·b_{ay} (27)

In Expression (27), the coefficients A and B are decided by the detection value ω_{zi} of the gyro sensor 14 at the time tᵢ and the detection value ω_{z,i-1} of the gyro sensor 14 at the preceding time tᵢ₋₁. That is, the acceleration sensor 12 is rotated to acquire the detection value fₓᵢ of the acceleration sensor 12 at each time tᵢ, whereby the X-axis establishment conditional expression (Expression (27)) at each time tᵢ can be obtained. The X-axis establishment conditional expression at each time tᵢ (where i=0, 1, . . . ) is represented as a simultaneous equation, and the approximate solutions of the bias values bₐₓ and b_{ay} of the acceleration sensor 12 can be obtained by approximation computation, such as a least squares method.

The same applies to the Y axis. That is, the detection value f_{yO} of the Y axis at the time t_{O} during stop of the acceleration sensor 12 and the detection value fₓ of the Y axis at the time tᵢ (where i=1, 2, . . . ) during rotation are expressed by Expression (28).

$${f}_{y 0} = - g \cdot sin {φ}_{0} \cdot cos {θ}_{0} + {b}_{ay} \\ {f}_{y 1} = - g \cdot sin {φ}_{1} \cdot cos {θ}_{1} + {b}_{ay} \\ {f}_{x 2} = - g \cdot sin {φ}_{2} \cdot cos {θ}_{2} + {b}_{ay} \\ ⋮ \\ {f}_{xi} = - g \cdot sin {φ}_{i} \cdot cos {θ}_{i} + {b}_{ay} \qquad ( 28 )$$

From Expression (28), Expressions (29) and (30) which respectively represent the bias value b_{ay} at the time t₁ and t₂ are established.

$$\begin{matrix}\begin{matrix}{f}_{y 1} + g \cdot sin {φ}_{1}^{t} \cdot cos {θ}_{1}^{t} = {f}_{y 1} + g \cdot {φ}_{1}^{t} \\ = {f}_{y 1} + g \cdot ( {φ}_{0}^{t} + {θ}_{0}^{t} \cdot {ω}_{z 1} \cdot dt + {ω}_{x 1} \cdot dt ) \\ = {f}_{y 1} + g \cdot ( {φ}_{1} + δφ + δθ \cdot {ω}_{z 1} \cdot dt ) \\ = {b}_{ay} - {b}_{ay} + g \cdot δθ \cdot {ω}_{z 1} \cdot dt \\ = - {b}_{ax} \cdot {ω}_{z 1} \cdot dt\end{matrix} & ( 29 ) \\ \begin{matrix}{f}_{y 2} + g \cdot sin {φ}_{2}^{t} \cdot cos {θ}_{2}^{t} = {f}_{y 2} + g \cdot {φ}_{2}^{t} \\ = {f}_{y 2} + g \cdot ( {φ}_{1}^{t} - {θ}_{1}^{t} \cdot {ω}_{z 2} \cdot dt + {ω}_{x 2} \cdot dt ) \\ = {f}_{y 2} + g \cdot ( {φ}_{2} + δφ + δθ \cdot ( {ω}_{z 1} + {ω}_{z 2} ) \cdot dt - \\ δφ \cdot {ω}_{z 1} \cdot {ω}_{z 2} \cdot {dt}^{2} ) \\ = {b}_{ay} - {b}_{ay} + g \cdot δθ \cdot ( {ω}_{z 1} + {ω}_{z 2} ) \cdot dt - \\ g \cdot δφ \cdot {ω}_{z 1} \cdot {ω}_{z 2} \cdot {dt}^{2} \\ = {b}_{ax} \cdot ( {ω}_{z 1} + {ω}_{z 2} ) \cdot dt - {b}_{ay} \cdot {ω}_{z 1} \cdot {ω}_{z 2} \cdot {dt}^{2}\end{matrix} & ( 30 )\end{matrix}$$

That is, as shown in Expression (31), it can be said that the expression “f_{y}+g·sin φ^{t}·cos θ^{t}” which represents the bias value b_{ay} of the Y axis is a linear combination of the bias values bₐₓ and b_{ay} of unknowns. Expression (31) is called “Y-axis establishment conditional expression”.

f_{y}+g·sin φ^{t}·cos θt=C·bₐₓ+D·b_{ay} (31)

In Expression (31), the coefficients C and D are decided by the detection value ω_{zi} of the gyro sensor 14 at the time tᵢ and the detection value ω_{z,i-1} of the gyro sensor 14 at the preceding time tᵢ₋₁. That is, the acceleration sensor 12 is rotated to acquire the detection value f_{yi} of the acceleration sensor 12 at each time tᵢ, whereby the Y-axis establishment conditional expression (Expression (31)) at each time tᵢ can be obtained. The Y-axis establishment conditional expression at each time tᵢ (where i=0, 1, . . . ) is represented as a simultaneous equation, and the approximate solutions of the bias values bₐₓ and b_{ay} of the acceleration sensor 12 can be obtained by approximation computation, such as a least squares method.

### Experiment Result

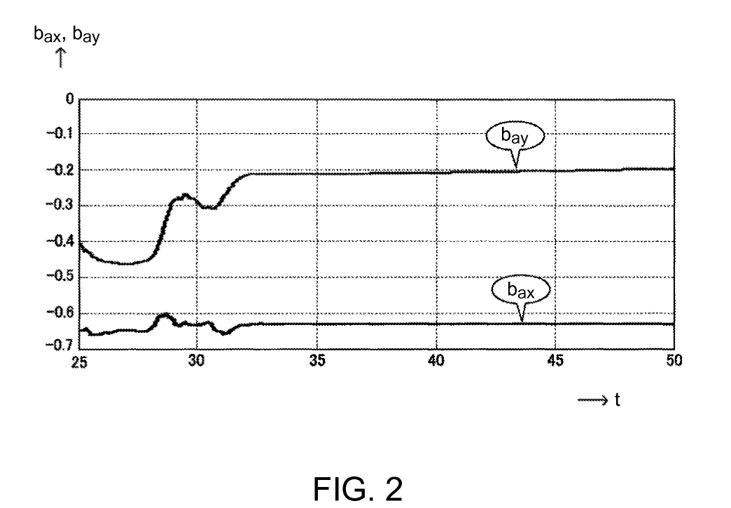

An experiment result using the calculation principle of the acceleration bias bₐ of this embodiment will be described. FIG. 2 shows an experiment result when a subject performs a waist rotation operation with (a device including) an IMU mounted thereon. A single waist rotation operation of this experiment includes twisting the waist in one direction (for example, a right direction), twisting the waist in an opposite direction (for example, a left direction), and facing the front. After facing the front, the operation is stopped without any change. In FIG. 2, the horizontal axis represents the time t and the vertical axis represents the bias values bₐₓ and b_{ay} of the X and Y axes of the acceleration sensor 12. A period of the time t=25 to 32 corresponds to a period during waist rotation.

In this experiment, the X-axis and Y-axis establishment conditional expressions are generated based on the detection value fᵢ of the acceleration sensor 12 and the detection value ωᵢ of the gyro sensor 14 at each time tᵢ (=tᵢ₋₁+dt) having a time interval dt from the start of waist rotation. The bias values bₐₓᵢ and b_{ayi} of the acceleration sensor 12 at the time tᵢ are calculated by a successive least squares method, which is one of successive approximation methods (successive estimation methods) using the X-axis and Y-axis establishment conditional expressions from the start time t₁ to the time tᵢ. As shown in Expressions (23) and (25) as an example, the attitude angles φᵢ and θᵢ at the time tᵢ are updated for the attitude angles φᵢ₋₁ and the θᵢ₋₁ at the preceding time tᵢ₋₁ and calculated based on the detection value ωᵢ of the gyro sensor 14. The successive least squares method is a known method, thus, detailed description thereof will be omitted.

According to the experiment result, although the acceleration bias bₐₓ and b_{ay} vary and become unstable immediately after the start of waist rotation, the acceleration bias values bₐₓ and b_{ay} are substantially settled down (converge) to given values at the end of waist rotation (around the time t=32). Finally, from the experiment result, the acceleration bias bₐ is calculated to be the X-axis acceleration bias bₐₓ≅−0.62 [m/s/s] and the Y-axis acceleration bias b_{ay}≅−0.2 [m/s/s]. In this experiment, as a result of successively performing waist rotation again and calculating the bias similarly, the bias is calculated to be the X-axis acceleration bias bₐₓ≅−0.6 [m/s/s] and the Y-axis acceleration bias b_{ay}≅−0.2 [m/s/s]. More accurate values obtained separately are the X-axis acceleration bias bₐₓ=−0.56 [m/s/s] and the Y-axis acceleration bias b_{ay}=−0.19 [m/s/s]. From this, the effect of this embodiment that the acceleration bias can be estimated with high precision by simple rotation operation in a short time can be confirmed.

### Functional Configuration

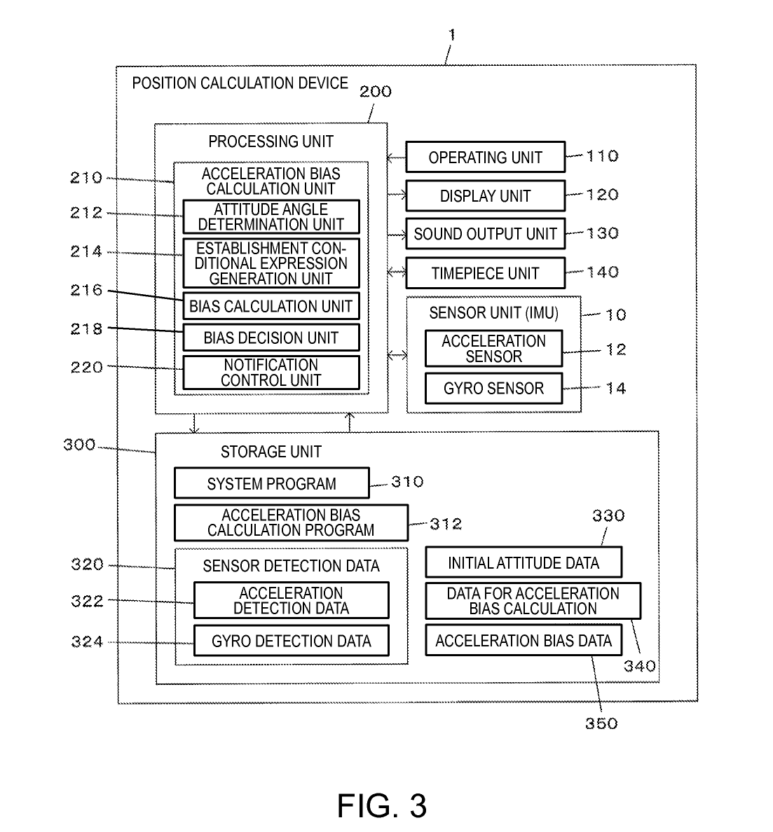

FIG. 3 is a block diagram showing the functional configuration of the position calculation device 1. Referring to FIG. 3, the position calculation device 1 includes a sensor unit 10, an operating unit 110, a display unit 120, a sound output unit 130, a timepiece unit 140, a processing unit 200, and a storage unit 300.

The sensor unit 10 is a sensor unit which includes an inertial sensor (IMU), and has an acceleration sensor 12 and a gyro sensor 14. A detection value of the sensor unit 10 is output to the processing unit 200.

The operating unit 110 is realized by, for example, an input device, such as a touch panel or a button switch, and outputs an operation signal according to operation to the processing unit. The display unit 120 is realized by, for example, a display device, such as an LCD, and performs various kinds of display based on a display signal from the processing unit. The sound output unit 130 is realized by, for example, a sound output device, such as a speaker, and performs various kinds of sound output based on a sound signal from the processing unit. The timepiece unit 140 is an internal timepiece of the position calculation device 1, has an oscillation circuit having a crystal oscillator or the like, and outputs a time signal, such as a measured current time or an elapsed time from a designated timing, to the processing unit 200.

The processing unit 200 is realized by, for example, an arithmetic device, such as a CPU, and performs overall control of the position calculation device 1 based on programs or data stored in the storage unit 300, an operation signal from the operating unit 110, or the like. The processing unit 200 corrects the detection values from the sensor unit 10 by acceleration bias data 350 obtained in an initial setting, calculates the position using the values after correction, and displays the calculated position on the display unit 120. In this embodiment, the processing unit 200 includes an acceleration bias calculation unit 210 as a function unit which obtains acceleration bias data 350.

The acceleration bias calculation unit 210 has an attitude angle determination unit 212, an establishment conditional expression generation unit 214, a bias calculation unit 216, a bias decision unit 218, and a notification control unit 220, and calculates the bias values bₐ=(bₐₓ, b_{ay}, b_{az}) of the respective detection axes (X, Y, and Z axes) of the acceleration sensor 12 based on the detection values of the sensor unit 10.

The attitude angle determination unit 212 calculates the initial attitude angles φ_{O} and θ_{O}, which are the attitude angles during stop, by Expression (4) based on the detection values f=(fₓ, f_{y}, f_{z}) of the acceleration sensor 12 during stop. Subsequently, the attitude angles φᵢ and θᵢ at the current time tᵢ are calculated by Expressions (23) and (25) based on the attitude angles φᵢ₋₁ and θᵢ₋₁ at the preceding time tᵢ₋₁ and the detection values ω₁=(ωₓᵢ, ω_{yi}, ω_{zi}) of the gyro sensor 14. The calculated initial attitude angles φ_{O} and δ_{O} are stored as initial attitude data 330. The attitude angles φᵢ and θᵢ at the time tᵢ are accumulated and stored in data 340 for acceleration bias calculation in association with the time tᵢ. The calculation of the initial attitude angles φ_{O} and θ_{O} and the calculation of the attitude angles φᵢ and θᵢ at the time t₁ correspond to the determination of the attitude angles.

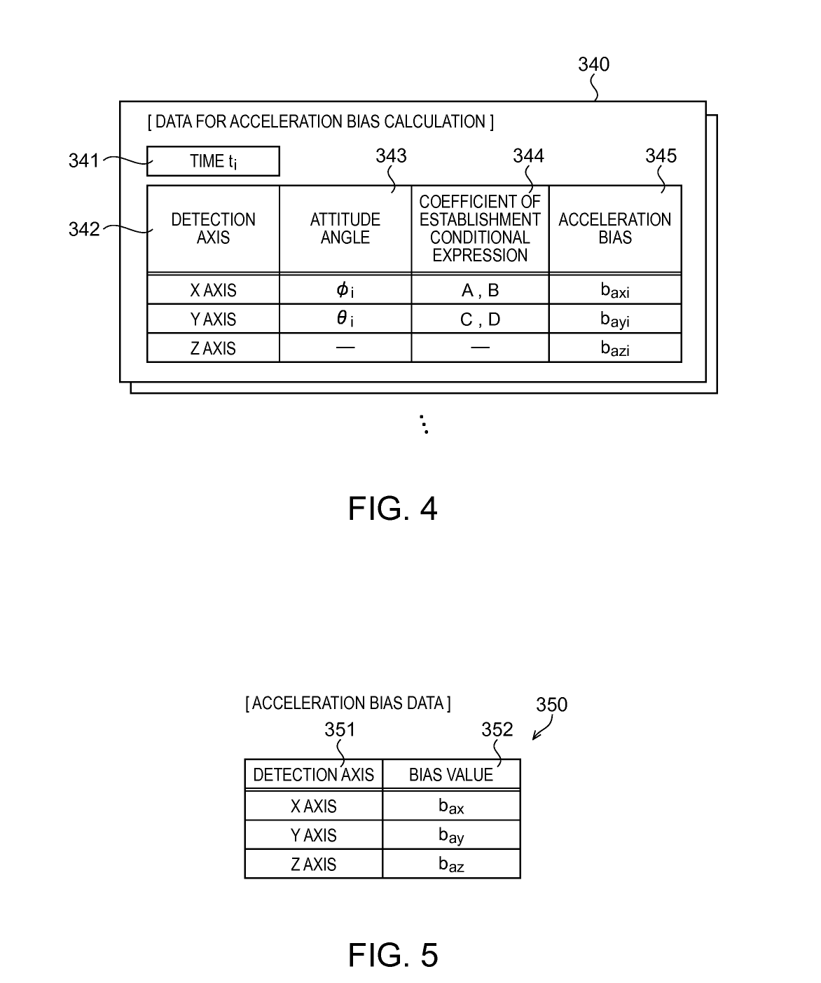

FIG. 4 shows a data configuration example of data 340 for acceleration bias calculation. As shown in FIG. 4, data 340 for acceleration bias calculation is generated at every time 341 and stores an attitude angle 343, a coefficient 344 of an establishment conditional expression, and an acceleration bias 345 in association with each detection axis 342 of the acceleration sensor 12.

The establishment conditional expression generation unit 214 calculates the X-axis and Y-axis establishment conditional expressions, which are instantaneous establishment conditions at the time tᵢ, by Expressions (27) and (31) based on the detection values fᵢ=(fₓᵢ, f_{yi}, f_{zi}) of the acceleration sensor 12, the detection values φᵢ=(ωₓᵢ, ω_{yi}, ω_{zi}) of the gyro sensor 14, and the attitude angles φᵢ and θᵢ. The coefficients A to D in the calculated X-axis and Y-axis establishment conditional expressions are accumulated and stored in data 340 for acceleration bias calculation in association with the time tᵢ.

The bias calculation unit 216 calculates the acceleration bias bₐᵢ at the time tᵢ. Specifically, the X-axis and Y-axis establishment conditional expressions at each time from t₁ to the time tᵢ are represented as a simultaneous equation, and a predetermined approximation operation (for example, a least squares method) for the simultaneous equation is performed, thereby calculating the bias values bₐₓ and b_{ay} of the X and Y axes at the time tᵢ. The bias value b_{azi} of the Z axis is calculated by Expression (3) based on the detection value f_{zi} of the Z axis of the acceleration sensor 12 and the attitude angles φᵢ and θᵢ. The calculated bias values bₐ=(bₐₓ, b_{ay}, b_{az}) are accumulated and stored in data 340 for acceleration bias calculation in association with the time tᵢ.

The bias decision unit 218 decides a final acceleration bias from the acceleration bias bₐᵢ at each time tᵢ during rotation. That is, as shown in FIG. 2, the acceleration bias bₐ converges to a given value with the lapse of a certain time, that is, with an increase in the number of X-axis and Y-axis establishment conditional expressions constituting a simultaneous equation. For this reason, convergence of the acceleration bias bₐᵢ during rotation with the lapse of time is determined, and the convergence value is decided as the final acceleration bias. In regard to the determination of convergence, for example, when the variation width of the acceleration bias for a predetermined time falls within a predetermined range, it may be determined that the acceleration bias converges to a given value, or a time differential of the value of the acceleration bias at each time tᵢ may be obtained, and when a predetermined condition in which the value of the time differential is around zero is satisfied consecutively a predetermined number of times, it may be determined that the acceleration bias converges to a given value. The decided acceleration bias is stored as acceleration bias data 350. The position calculation of the device is performed using the decided acceleration bias bₐ=(bₐₓ, b_{ay}, b_{az}).

FIG. 5 shows a data configuration example of acceleration bias data 350. As shown in FIG. 5, acceleration bias data 350 stores a bias value 352 of each detection axis 351 of the acceleration sensor 12.

The notification control unit 220 performs necessary notification control to the user at the time of the calculation of the acceleration bias. Specifically, when the sum of the initial attitude angles φ_{O} and θ_{O} exceeds a predetermined angle (for example, 10 degrees) (φ_{O}+θ_{O}>10 degrees), a predetermined notification message to prompt the user to remount the device in a recommending attitude is output by sound from the sound output unit 130, or a predetermined notification lamp or notification message is displayed and output on the display unit 120. In order to acquire an instantaneous bias bₐᵢ, a predetermined notification message to prompt the user to rotate the waist in the left-right direction in a state where the device is mounted is output by sound from the sound output unit 130, or a predetermined notification lamp or notification message is displayed and output on the display unit 120. Even when the bias decision unit 218 can determine convergence to decide the acceleration bias, notification control is performed, the user is informed of the completion of an initial setting relating to the decision and setting of the acceleration bias.

The storage unit 300 is realized by a storage device, such as a ROM or a RAM, stores programs, data, and the like which are used when the processing unit 200 integrally controls the position calculation device 1, and is used as a work area of the processing unit 200 to temporary store the result of operations executed by the processing unit 200 according to various programs, detection value data from the sensor unit 10, and the like. In this embodiment, the storage unit 300 stores a system program 310, an acceleration bias calculation program 312, sensor detection data 320, initial attitude data 330, data 340 for acceleration bias calculation, and acceleration bias data 350.

Sensor detection data 320 is accumulated data of the detection values of the sensor unit 10, and includes acceleration detection data 322, which is accumulated data of the detection values (acceleration) f of the acceleration sensor 12, and gyro detection data 324, which is accumulated data of the detection values (angular velocity) ω of the gyro sensor 14.

### Flow of Processing

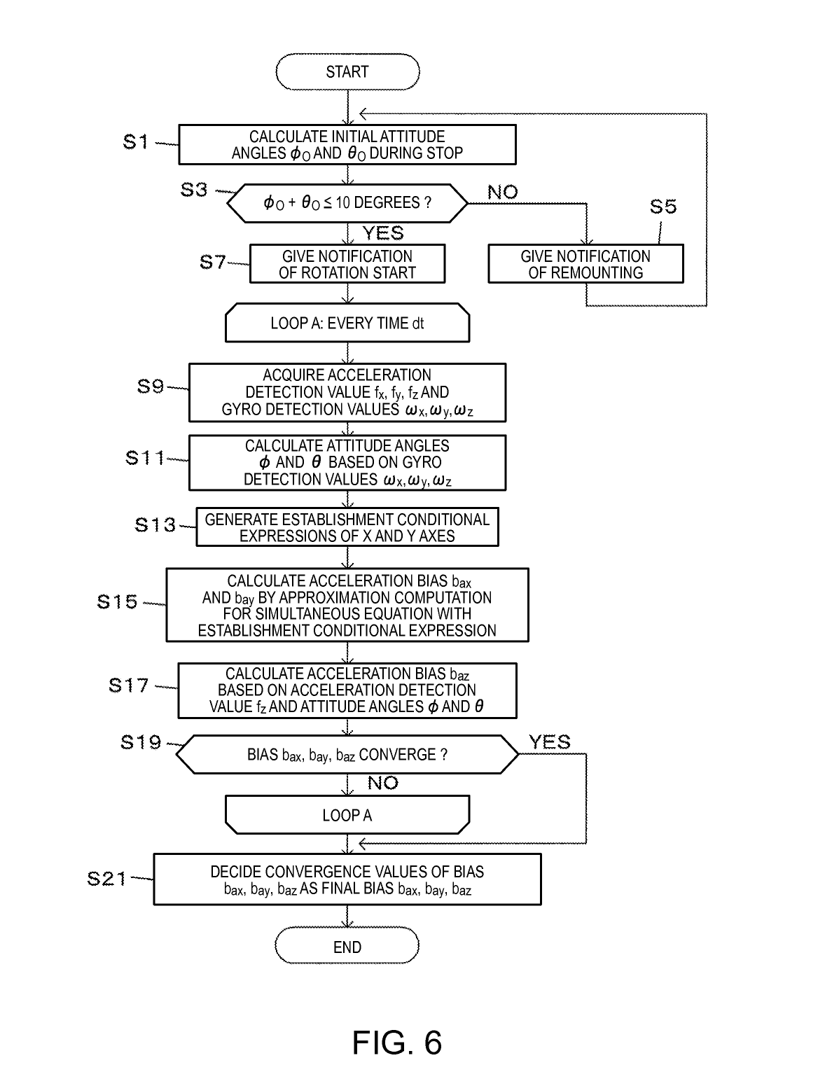

FIG. 6 is a flowchart illustrating the flow of acceleration bias estimation processing. This processing is processing which is executed by the acceleration bias calculation unit 210 according to the acceleration bias calculation program 312 prior to position calculation processing. For example, this processing is processing which is executed as an initial setting or is executed at an arbitrary timing at which calibration is required.

First, the attitude angle determination unit 212 calculates the initial attitude angles φ_{O} and θ_{O} based on the detection values f=(fₓ, f_{y}, f_{z}) of the acceleration sensor 12 (Step S1). Determination is performed about whether or not the sum of the calculated initial attitude angles φ_{O} and θ_{O} is equal to or less than 10 degrees (Step S3). If the sum of the initial attitude angles exceeds 10 degrees (Step S3: NO), the notification control unit 220 performs predetermined notification to prompt the user to remount the device in a recommending posture (Step S5). Thereafter, the attitude angle determination unit 212 calculates the initial attitude angles φ_{O} and θ_{O} again (Step S1).

If the sum of the initial attitude angles φ_{O} and θ_{O} is equal to or less than 10 degrees (Step S3: YES), the notification control unit 220 performs predetermined notification to prompt the user to rotate the waist in the left-right direction (Step S7).

Thereafter, processing of a loop A is repeatedly executed at a predetermined time interval dt. In the loop A, first, the detection values fᵢ=(fₓᵢ, f_{yi}, f_{zi}) of the acceleration sensor 12 and the detection values ωᵢ=(ωₓᵢ, ω_{yi}, ω_{zi}) of the gyro sensor 14 at the time tᵢ are acquired (Step S9). Next, the attitude angle determination unit 212 calculates the attitude angles φᵢ and θᵢ at the time tᵢ based on the detection values ωᵢ of the gyro sensor 14 (Step S11).

Subsequently, the establishment conditional expression generation unit 214 generates the X-axis and Y-axis establishment conditional expressions at the time tᵢ based on the detection values fᵢ of the acceleration sensor 12, the detection values ωᵢ of the gyro sensor 14, and the attitude angles φᵢ and θᵢ at the time tᵢ (Step S13). The generated X-axis and Y-axis establishment conditional expressions are added to update the simultaneous equation, and a predetermined approximation computation (for example, a least squares method) for the updated simultaneous equation is performed, thereby calculating the bias values bₐₓᵢ and b_{ayi} at the time tᵢ (Step S15). The acceleration bias value b_{azi} of the Z axis is calculated based on the detection values fᵢ of the acceleration sensor 12 and the attitude angles φᵢ and θᵢ (Step S17).

Subsequently, the bias decision unit 218 performs determination about whether or not the acceleration bias bₐᵢ calculated at each time from the start time t₁ to the current time tᵢ converges to a given value range (Step S19). If the acceleration bias does not converge to a given value range (Step SS19: NO), the processing of the loop A is repeated. If the acceleration bias converges to a given value range (Step S19: YES), the processing of the loop A ends, then, the convergence value of the acceleration bias value bᵢ is decided as the final acceleration bias value and set as acceleration bias data 350 (Step S21). Then, the acceleration bias calculation processing ends.

### Functional Effect

As described above, according to this embodiment, the position calculation device 1 having the IMU 10 is mounted on the waist of the user 20, and the bias values b=(bₐₓ, b_{ay}, b_{az}) of the acceleration sensor 12 can be calculated by simple rotation operation of the user 20 in the left-right direction. The position calculation device 1 may be mounted on the user 20 such that the Z axis of the acceleration sensor 12 turns vertically downward and the X-Y plane is substantially horizontally placed.

In the above-described embodiment, when the acceleration sensor 12 is rotated, if the Z axis and the rotation axis substantially conform to each other, a rotation force other than gravity is negligible, and it can be regarded that only gravity in a vertically downward direction is applied. This will be described in detail. When the acceleration sensor 12 is rotated, a centrifugal acceleration a which is applied in the X-Y plane direction is decided by a rotation acceleration ω and a rotation radius R and is given by a=ω²·R. From the experiment result of the inventors, it is understood that, if the centrifugal acceleration a is equal to or less than 0.1 times the gravitational acceleration g (a≦0.1 g), error in the calculation of the acceleration bias is negligible in disregard of the centrifugal acceleration a.

When the user 20 rotates the waist with the position calculation device 1 (acceleration sensor 12) mounted on the waist, the upper limits of the rotation radius R and the rotation acceleration ω are considered. For example, when the user 20 has an adult waist size of 85 cm, the rotation radius R becomes about R=13 cm. In this case, if the rotation acceleration ω is ω≦2 [rps], the centrifugal acceleration a is a≦0.52 [m/s/s] and is negligible. However, if the rotation acceleration ω is ω≧3 [rps], the centrifugal acceleration a is a≧1.17 [m/s/s] and is not negligible. That is, it should suffice that the user 20 having a normal body shape rotates the waist at the rotation angle ω of about 1 to 2 [rps].

### Modification Example

Although the embodiment of the invention has been described, a form to which the invention can be applied is not limited to the above-described embodiment.

For example, although a case where the Z axis of the acceleration sensor 12 is the vertical direction has been described, the X axis or the Y axis may be the vertical direction. This is because, if one axis of the orthogonal three axes is the vertical direction, a plane defined by the other two axes becomes a horizontal plane. In this case, the other two axes included in the plane correspond to a first axis and a second axis.

In regard to the rotation around the vertical direction as the axial center, the Z axis is not necessarily the axial center, eccentric rotation with the Z axis in the vertical direction may be performed.

Although a case where the position calculation device 1 is mounted on the waist of the user 20 for use has been described, the position calculation device 1 may be mounted on a part of a trunk other than the waist such as a breast, or a head, or a leg for use. In regard to the calculation of the acceleration bias, if rotation around the vertical direction as the axial center is performed in a state where the Z axis is placed in the vertical direction, the mounting position is arbitrary.

Although a case where an acceleration bias is calculated by a least squares method using the establishment conditional expressions of the X and Y axes obtained at each time tᵢ has been described, other approximation computation (estimation computation) may be used. For example, an acceleration bias may be calculated using a Kalman filter or a maximum likelihood estimation method.

Although a case where an operation to rotate a waist in the left-right direction is performed has been described, the position calculation device 1 may be rotated by 360 degrees around the vertical direction as the axial center. Since conditions variation with respect to the use of the position calculation device 1 is small, it is preferable that rotation is performed in a state of being mounted on the user 20, rotation may be performed in a state of being placed on a substantially horizontal ground or the like, and if rotation around the vertical direction as the axial center is possible, a way of rotating is arbitrary.

Although the position calculation device 1 has been described as an example, the invention may be similarly applied to other electronic apparatuses, such as a portable sports apparatus, a mobile phone, a personal computer, and a PDA (Personal Digital Assistant), whereby it is possible to calculate the bias of the acceleration sensor 12.

What is claimed is:

1. A bias calculation method comprising:
calculating a bias of a first axis and a second axis of an acceleration sensor using a detection value of a sensor unit including the acceleration sensor and a gyro sensor acquired when the sensor unit is rotated around a vertical direction as an axial center in a state where a plane defined by the first axis and the second axis of the acceleration sensor is substantially perpendicular to the vertical direction.

2. The bias calculation method according to claim 1,
wherein the calculating of the bias includes
calculating a plurality of instantaneous establishment conditions, in which the attitude of the sensor unit is represented using the detection value with the bias as an unknown, during the rotation, and
deciding the bias using the plurality of instantaneous establishment conditions.

3. The bias calculation method according to claim 2, further comprising:
determining the attitude angle of the sensor unit using the detection value of the sensor unit,
wherein, in the calculating of the instantaneous establishment conditions, the instantaneous establishment conditions are calculated using the detection value, the attitude angle, and a gravitational acceleration.

4. The bias calculation method according to claim 3,
wherein, in the determining of the attitude angle, an initial attitude angle is determined using a detection value of the acceleration sensor in a state where the sensor unit is stopped and the gravitational acceleration, and a previously determined attitude angle is updated using a detection value of the gyro sensor to determine an attitude angle in a plurality of attitudes.

5. The bias calculation method according to claim 2,
wherein, in the deciding of the bias, predetermined approximation computation using a plurality of instantaneous establishment conditions is performed to decide the bias.

6. The bias calculation method according to claim 1,
wherein, in the rotating, the sensor unit is rotated in a state where the sum of the angle between the first axis and a horizontal plane perpendicular to the vertical direction and the angle between the second axis and the horizontal plane is equal to or less than 10 degrees.

7. The bias calculation method according to claim 1,
wherein the sensor unit is mounted on a trunk, a head, or a leg of a user for use.

8. A bias calculation device comprising:
a sensor unit having an acceleration sensor and a gyro sensor;
a notification control unit which gives notification to the effect of rotating the sensor unit around a vertical direction as an axial center in a state where a plane defined by the first axis and the second axis of the acceleration sensor is substantially perpendicular to the vertical direction; and
a bias calculation unit which calculates the bias of the first axis and the second axis of the acceleration sensor using a detection value of the sensor unit.

9. A bias calculation device comprising:
a sensor unit having an acceleration sensor and a gyro sensor; and
a bias calculation unit which calculates the bias of each of a first axis and a second axis of the acceleration sensor using a detection value of the sensor unit acquired when the sensor unit is rotated around a vertical direction as an axial center in a state where a plane defined by the first axis and the second axis of the acceleration sensor is substantially perpendicular to the vertical direction.
